(19) United States
(12) Patent Application Publication
(10) Pub. No.: US 2019/0113872 A1
(43) Pub. Date: Apr. 18, 2019

(54) IMAGE FORMING APPARATUS, INFORMATION PROCESSING METHOD, AND STORAGE MEDIUM

(71) Applicant: CANON KABUSHIKI KAISHA, Tokyo (JP)

(72) Inventor: Yukio Kanakubo, Tsukubamirai-shi (JP)

(21) Appl. No.: 16/154,119

(22) Filed: Oct. 8, 2018

(30) Foreign Application Priority Data
Oct. 13, 2017 (JP) 2017-199703

(51) Int. Cl. G03G 15/00; B29C 64/386; G03G 15/08; B33Y 40/00

(52) U.S. Cl. CPC G03G 15/556; B29C 64/386; G03G 15/0863; G06F 3/1208; G03G 15/5016; G03G 2215/0697; B33Y 40/00

(57) ABSTRACT

An image forming apparatus includes an acquisition unit that acquires a remaining lifetime of a consumable part and a control unit that records, in a case where access to a memory of the consumable part is possible, a set value in a storage region of the memory corresponding to the remaining lifetime.

### BACKGROUND

### Field

Aspects of the present disclosure generally relate to an image forming apparatus, an information processing method, and a storage medium.

### Description of the Related Art

Some image forming apparatuses can employ a configuration in which users themselves replace consumable parts such as toner cartridges. The image forming apparatus notifies the user of information about the lifetime of consumable parts via, for example, an operation panel and the user prepares replacement parts in advance, so that a downtime in which the image forming apparatus is not able to be used due to the reached lifetime of consumable parts is shortened. Such information about the lifetime of consumable parts is generally recorded in a non-volatile memory (memory tag).

At a timing when consumable parts become required to be replaced, to adequately notify the user of the need for replacement, it becomes important to increase the prediction accuracy of the lifetime information about consumable parts.

For example, Japanese Patent Application Laid-Open No. 2015-49325 discusses a method of increasing the prediction accuracy by predicting the lifetime based on page counting in a case where the memory tag has no record of lifetime information.

When the image forming apparatus becomes unable to gain access to a memory tag of a consumable part due to any cause, such as a connection terminal between the image forming apparatus body and the memory tag being soiled with a recording material of toner, it becomes impossible to update the lifetime information about the consumable part which should be updated by a printing operation of the image forming apparatus. Therefore, even when the body and the memory tag can gain access to each other again, it becomes impossible to perform correct lifetime calculation. This can result in the user replacing a consumable part at an incorrect timing or printing becomes faded even without displaying that the reached lifetime occurred.

At this time, even if a service engineer checks the consumable part in response to a notification from the user, it is difficult for the service engineer to discern what has caused the issue.

### SUMMARY OF THE INVENTION

According to an aspect of the present disclosure, an image forming apparatus includes an acquisition unit configured to acquire a remaining lifetime of a consumable part, and a control unit configured to record, in a case where access to a memory of the consumable part is possible, a set value in a storage region of the memory corresponding to the remaining lifetime.

Further features will become apparent from the following description of exemplary embodiments with reference to the attached drawings.

### BRIEF DESCRIPTION OF THE DRAWINGS

FIG. 1 is a diagram illustrating an example of a system configuration of a printing system.

FIG. 2 is a diagram illustrating an example of a hardware configuration of a device.

FIG. 3 is a diagram illustrating an example of a memory map of a memory tag of a consumable part.

FIG. 4 is a diagram for explaining a correspondence between a remaining lifetime of a cartridge and a region of the memory tag.

FIG. 5 is a flowchart illustrating an example of information processing.

FIG. 6 is a diagram illustrating an example of data recorded on the memory tag.

### DESCRIPTION OF THE EMBODIMENTS

Various exemplary embodiments, features, and aspects of the disclosure will be described in detail below with reference to the drawings.

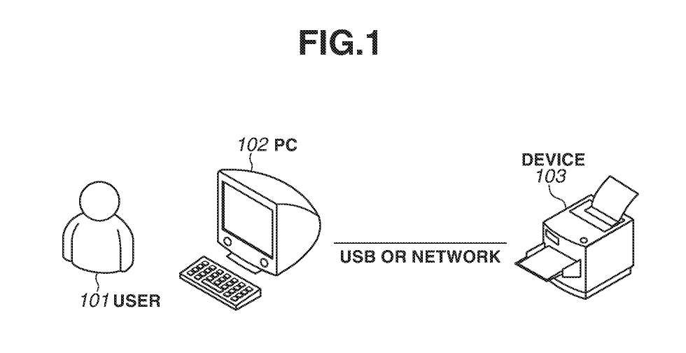

FIG. 1 is a diagram illustrating an example of a system configuration of a printing system according to a first exemplary embodiment.

A device (also referred to as an “image forming apparatus”) 103 is connected to a personal computer (PC) 102 via a universal serial bus (USB) or a network. The user 101 can perform any optional setting or instruction to the device 103 by operating an operation unit of the PC 102 or an operation and display unit 216 of the device 103.

The device 103 can transmit an image or information to the PC 102 connected thereto via a USB or a network. The device 103 can also receive print data from the PC 102 and then perform printing. While, in the first exemplary embodiment, a printer including the operation and display unit 216 in the body thereof is described as an example of the device 103, the device 103 is not limited to a printer, and can be another type of image forming apparatus, such as a multifunction peripheral (MFP) or a three-dimensional (3D) printer.

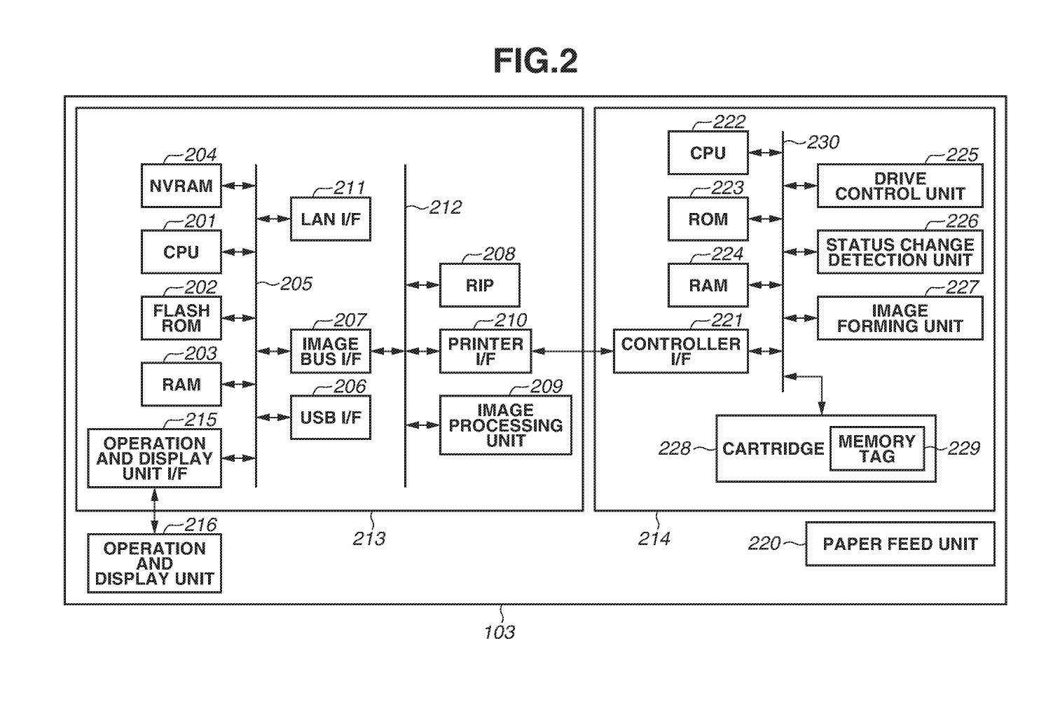

FIG. 2 is a diagram illustrating an example of a hardware configuration of a controller unit 213, a printer engine 214, and device elements connected thereto of the device 103.

The controller unit 213 is connected to the printer engine 214, which serves as an image output device, and performs inputting and outputting of image data and device information between the PC 102 and the printer engine 214. The controller unit 213 is connected to the operation and display unit 216 and can receive any optional setting or instruction from the user. A central processing unit (CPU) 201 is a processor which controls the entire system. A random access memory (RAM) 203 is a system work memory used for the CPU 201 to operate, and is also a program memory on which to record a program and an image memory on which to temporarily record image data. A non-volatile RAM (NVRAM) 204 is a non-volatile memory and is used to record thereon, for example, setting information. A flash read-only memory (ROM) 202 is a rewritable non-volatile memory, on which various control programs for controlling the system are recorded. A control program related to processing for recording a remaining lifetime history of a consumable part is also stored in the flash ROM 202, and is executed by the CPU 201. An operation and display unit interface (I/F) 215 is an interface unit connected with the operation and display unit 216 and assumes the role of receiving an input signal from the operation and display unit 216 and also communicating, to the CPU 201, information input by the user via the operation and display unit 216. The operation and display unit IF 215 outputs an output signal to the operation and display unit 216 based on control performed by the CPU 201. In the first exemplary embodiment, the operation and display unit 216 includes a liquid crystal display unit including a touch panel function and various hardware keys, and functions as a display unit that displays information and a reception unit that receives an instruction from the user. A USB I/F 206 enables USB connection to the PC 102. A local area network (LAN) I/F 211 enables LAN connection to the PC 102. The above-mentioned device elements are located on a system bus 205. An image bus I/F 207 is a bus bridge that interconnects the system bus 205 and an image bus 212, which transfers image data at high speed, and transforms a data structure. The image bus 212 can be a Peripheral Component Interconnect (PCI) bus or an Institute of Electrical and Electronics Engineers (IEEE) 1394 bus. The following device elements are located on the image bus 212. A raster image processor (RIP) 208 rasterizes vector data, such as page-description language (PDL) code, into a bitmapped image. A printer I/F 210 interconnects the printer engine 214 and the controller unit 213 and performs synchronous or asynchronous conversion of image data and communication of data. An image processing unit 209 performs correction, processing, and editing on input image data, and performs correction of a printer and resolution conversion on print output image data. The image processing unit 209 performs rotation of image data or compression and decompression processing, such as Joint Photographic Experts Group (JPEG) on multivalued image data or Joint Bi-level Image Experts Group (JBIG), Modified Modified READ (MMR), or Modified Huffman (MH) coding on binary image data.

The printer engine 214 is a unit for printing an image on a sheet based on rasterized image data received from the controller unit 213. A controller I/F 221 interconnects the printer engine 214 and the controller unit 213 and performs synchronous or asynchronous conversion of image data and communication of data. A CPU 222 loads a program stored in a ROM 223 onto a RAM 224 and executes the program to control the printer engine 214. The ROM 223 stores, for example, a program that the CPU 222 executes. The RAM 224 stores, for example, a program loaded from the ROM 223. A drive control unit 225 drives various motors required for an image forming unit 227 to perform image formation. A status change detection unit 226 detects a status change, such as jam or opening of a cover, in the image forming apparatus. The status change detection unit 226 also detects replacement of a cartridge 228. Detection of a status change can be configured to be performed by the CPU 222. The image forming unit 227 prints an image on a sheet based on rasterized image data received from the controller unit 213. While, in the present exemplary embodiment, the printing method employed in the image forming unit 227 is an electrophotographic method in which an image is formed by forming an electrostatic latent image on a photosensitive drum, developing the latent image with toner, transferring the toner image to a sheet, and then fixing the transferred toner image, the present exemplary embodiment is not limited to this method. For example, another type of printing method, such as an inkjet method in which an image is directly formed on a sheet by ejecting ink from a minute nozzle array or a thermal transfer method, can also be adopted. In a case where the inkjet method is employed, a recording material stored in a cartridge is assumed to be ink. In a case where the thermal transfer method is employed, an ink ribbon is assumed to be used instead of a cartridge.

In a case where the device 103 is a 3D printer, a cartridge containing a recording material, such as a liquid resin or a thermoplastic resin, is used. In the case of a 3D printer, the printer engine 214 serves as a shape forming unit that forms a three-dimensional shape by performing stacking in layers. The printer engine 214 reciprocates a shape forming head, which ejects a recording material, such as a liquid resin or a thermoplastic resin, along the main scanning direction and also moves the shape forming head in the sub-scanning direction, thus stacking one layer of cross-section shape. Then, after the shape forming material is hardened, a shape forming stage is moved in vertical direction. Repeating the above processing causes cross-section shapes to be stacked in layers, thus forming the shape of a 3D object.

A bus 230 connects elements included in the printer engine 214 with each other.

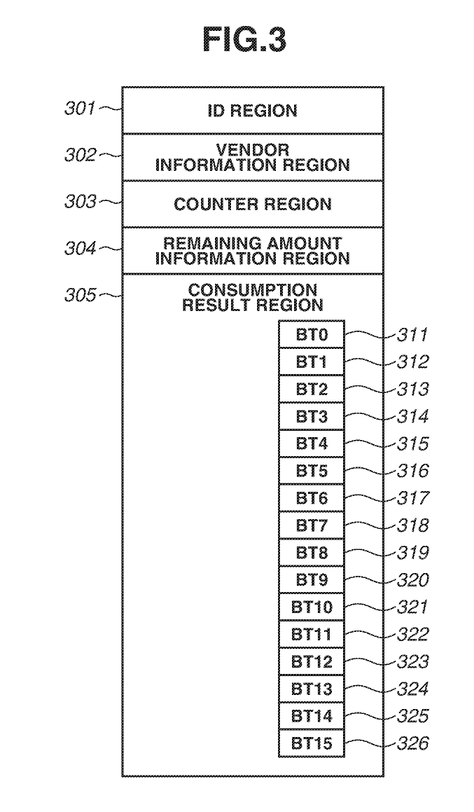

The cartridge 228 is what is called a process cartridge, which serves as a container portion containing toner and is attachable to the device 103, and stores, for example, toner used for the image forming unit 227 to perform image formation. The cartridge 228 includes a memory tag 229, which is a non-volatile storage medium, in which information concerning the cartridge 228 is stored. A history of toner remaining lifetime values is also recorded on the memory tag 229. Details of information stored in the memory tag 229 are described below with reference to FIG. 3. The cartridge 228 is connected to the bus 230, but can be configured to connect to the CPU 222 via a dedicated line. While, in the hardware configuration example illustrated in FIG. 2, the cartridge 228 is used as an example of a consumable part, another type of consumable part, such as a fixing device, can be employed.

Sheets to be used for printing are stored in a paper feed unit 220.

The activation of the printing operation is started in response to an instruction from the CPU 201.

FIG. 3 is a diagram illustrating an example of a memory map of the memory tag 229 of the cartridge 228.

An ID region 301 is a region in which a unique identifier (ID) for identifying the cartridge 228 is written. The unique ID is uniquely allocated to the cartridge 228. A vendor information region 302 is a region in which information indicating the vendor of the cartridge 228 is written. A counter region 303 is a region in which the number of pages for which printing was performed since the cartridge 228 was attached to the device 103 is written. A remaining amount information region 304 is a region used to record and retain the remaining amount (remaining lifetime) of each consumable part obtained by, for example, calculation. A consumption result region 305 is a region used to record a history of remaining lifetimes of a consumable part. In the present exemplary embodiment, a 16-bit region is allocated as the consumption result region 305, and values of remaining lifetimes are allocated to the respective bits 311 to 326.

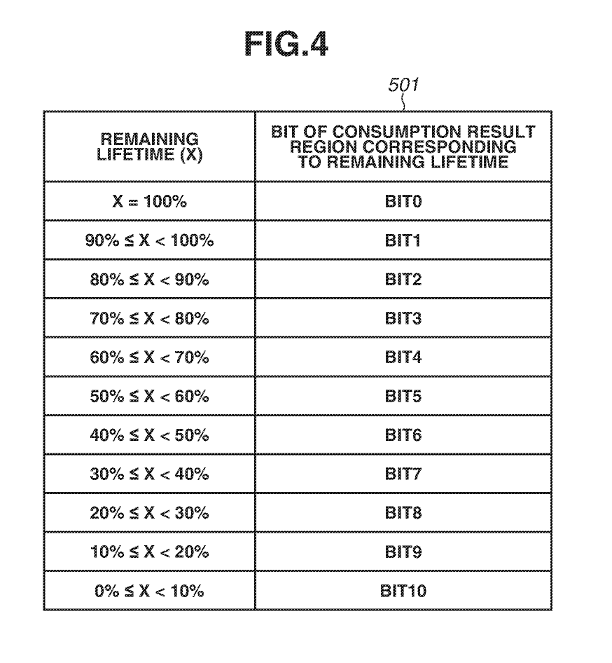

FIG. 4 is a diagram for explaining a correspondence table 501 between remaining lifetimes of the cartridge and bits 311 to 321 of the consumption result region 305 of the memory tag 229 used for recording a history of remaining lifetimes.

The device 103 records a history by setting a bit of the consumption result region 305 of the memory tag 229 corresponding to the current remaining lifetime of the cartridge to “1”. For example, with regard to a new cartridge, zero is stored as an initial value in each bit of the consumption result region 305. In a case where a new cartridge is attached, the device 103 rewrites a bit BIT0 of the consumption result region 305 to “1”. In a case where the cartridge has been used for recording and the remaining lifetime thereof has reached the 90% level (90%≤remaining lifetime <100%), the device 103 rewrites a bit BIT1 of the consumption result region 305 to “1”.

Thus, in a case where the operation of the device 103 is performed in a state in which the device 103 can access the memory tag 229 of the cartridge, when the cartridge has come to the end of the lifetime thereof, a state in which all of the bits 311 to 326 were rewritten to “1” occurs.

For example, X=100%, 90%≤X<100%, and 80%≤X<90% illustrated in FIG. 4 are examples of a plurality of remaining lifetime ranges. The bit of a consumption result region corresponding to the remaining lifetime illustrated in FIG. 4 is an example of a storage region of the non-volatile memory corresponding to the remaining lifetime.

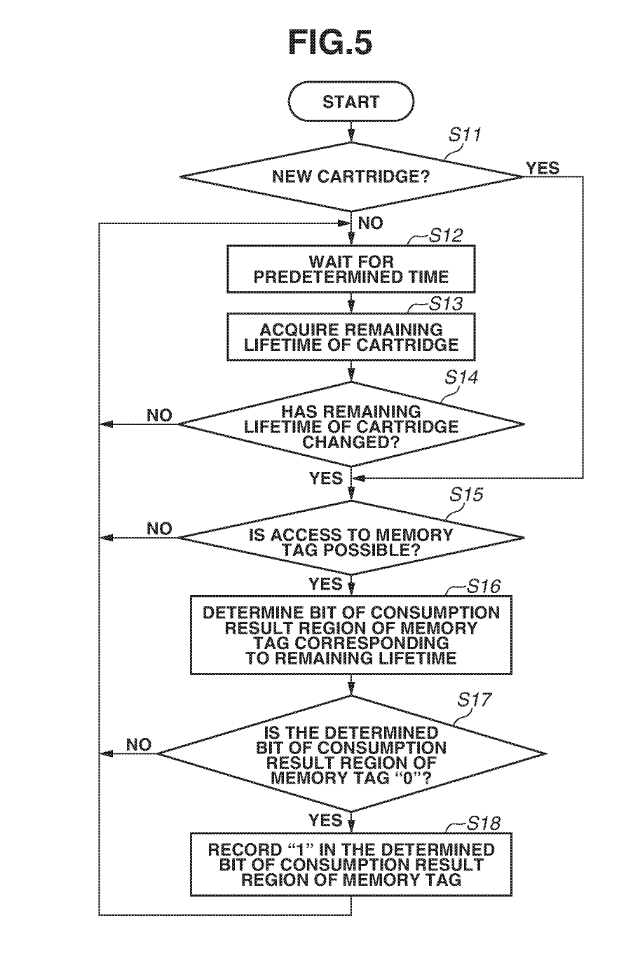

Next, information processing for recording a result of the cartridge remaining lifetime on the memory tag, which is performed in the device 103, is described with reference to the flowchart of FIG. 5.

Each operation (step) illustrated in the flowchart of FIG. 5 is implemented by the CPU 201 reading out a control program stored in the NVRAM 204 or the flash ROM 202 onto the RAM 203 and executing the read-out control program. Some processing operations illustrated in the flowchart are implemented in cooperation with the printer engine 214. Processing to be performed by the printer engine 214 is implemented by the CPU 222 reading out a control program stored in the ROM 223 onto the RAM 224 and executing the read-out control program.

In addition to the present processing, as processing that is performed in parallel, there is processing for print control. In the processing for print control, each time printing is performed for one page, the printer engine 214 updates the remaining lifetime of the cartridge.

In step S11, the CPU 201 determines whether the currently attached cartridge is a new cartridge. For example, the CPU 201 determines that the currently attached cartridge is a new cartridge based on information indicating that the remaining lifetime acquired from the printer engine 214 is 100%. However, the method of detecting a new cartridge is not limited to this method, and can be any other method. If it is determined that the currently attached cartridge is a new cartridge (YES in step S11), the CPU 201 advances the processing to step S15. If it is determined that the currently attached cartridge is not a new cartridge (NO in step S11), the CPU 201 advances the processing to step S12.

First, an operation performed in a case where the currently attached cartridge is a new cartridge is described. In step S15, the CPU 201 determines whether the CPU 201 can access the memory tag of the cartridge in cooperation with the printer engine 214. If it is determined that the CPU 201 can access the memory tag of the cartridge (YES in step S15), the CPU 201 advances the processing to step S16. If it is determined that the CPU 201 cannot access the memory tag of the cartridge (NO in step S15), the CPU 201 returns the processing to step S12.

In step S16, the CPU 201 determines a bit of the consumption result region 305 of the memory tag 229 corresponding to the remaining lifetime in the table illustrated in FIG. 4. More specifically, the bit corresponding to the remaining lifetime of 100% is the bit BIT0.

In step S17, the CPU 201 determines whether “0” is currently recorded in the bit BIT0 of the consumption result region 305 of the memory tag 229 determined in step S16. If it is determined that “0” is currently recorded (YES in step S17), the CPU 201 advances the processing to step S18. If it is determined that “1” is already recorded (NO in step S17), the CPU 201 returns the processing to step S12.

In step S18, the CPU 201 writes “1” to the bit BIT0 of the consumption result region 305 of the memory tag 229 determined in step S16 in cooperation with the printer engine 214. Upon completion of writing to the memory tag 229, the CPU 201 returns the processing to step S12.

In step S12, the CPU 201 waits a predetermined time.

In step S13, the CPU 201 acquires the remaining lifetime of the cartridge from the printer engine 214. The printer engine 214 calculates the remaining lifetime, for example, in the following way.

The printer engine 214 calculates a consumption amount of toner each time the printer engine 214 performs print processing for printing a print image on a sheet. The printer engine 214 counts the number of print dots constituting a print image used for printing for each print page (hereinafter referred to as “dot counting”), and then calculates the toner consumption amount for the entire page based on the toner consumption amount per dot. The printer engine 214 is able to calculate the current toner remaining amount of the cartridge by subtracting the calculated toner consumption amount from the current toner consumption amount recorded in the remaining amount information region 304 of the memory tag 229 each time the printer engine 214 performs printing. Then, the printer engine 214 records the calculated toner remaining amount in the remaining amount information region 304 of the memory tag 229. In a case where the consumable part is a cartridge, the proportion of the toner remaining amount to the toner amount with which a new cartridge is filled becomes the remaining lifetime of the cartridge. The printer engine 214 is provided with a sensor and measures the toner remaining amount included in the cartridge 228 based on an output of the sensor. The sensor to be employed includes, for example, a magnetic permeability detection type, a magnet type, a piezoelectric oscillation type, and a transmitted light type. The printer engine 214 can acquire information indicating that the toner remaining amount has reached predetermined values, such as 30% and 0%, based on an output of the sensor. Thus, when the toner remaining amount is 100% to 31%, the printer engine 214 acquires information indicating 100%. When the toner remaining amount is 30% to 1%, the printer engine 214 acquires information indicating 0%. When the toner remaining amount is 0%, the printer engine 214 acquires information indicating 0%. The sensor can be provided inside the cartridge 228. In the present exemplary embodiment, the printer engine 214 is assumed to calculate the current remaining lifetime of the cartridge based on a combination of a calculation result that is based on the dot counting and an acquisition result that is based on the sensor. For example, in a case where the CPU 201 cannot access the memory tag 229, the printer engine 214 sets the acquisition result that is based on the sensor as the current lifetime of the cartridge.

The method of calculating the remaining lifetime of the cartridge is not limited to this method, and can be any other method.

In step S14, the CPU 201 determines whether the remaining lifetime of the cartridge acquired in step S13 has changed as compared with a previous value. If it is determined that the remaining lifetime has not changed (NO in step S14), the CPU 201 returns the processing to step S12. If it is determined that the remaining lifetime has changed (YES in step S14), the CPU 201 advances the processing to step S15.

In step S15, the CPU 201 determines whether the CPU 201 can access the memory tag of the cartridge in cooperation with the printer engine 214. If it is determined that the CPU 201 can access the memory tag (YES in step S15), the CPU 201 advances the processing to step S16. If it is determined that the CPU 201 cannot access the memory tag (NO in step S15), the CPU 201 returns the processing to step S12.

In step S16, the CPU 201 determines to which bit of the consumption result region 305 of the memory tag 229 the remaining lifetime of the cartridge acquired in step S13 corresponds, based on the table illustrated in FIG. 4. For example, if the remaining lifetime is 75%, it is determined that the corresponding bit of the consumption result region 305 is a bit BIT3.

In step S17, the CPU 201 reads in the bit of the consumption result region 305 of the memory tag 229 determined in step S16 and determines whether the read-in bit is “0”. If it is determined that “1” is already recorded (NO in step S17), the CPU 201 returns the processing to step S12. If it is determined that the read-in bit is “0” (YES in step S17), the CPU 201 advances the processing to step S18.

In step S18, the CPU 201 writes “1” to the bit of the consumption result region 305 of the memory tag 229 determined in step S16 in cooperation with the printer engine 214. “1” is an example of a set value.

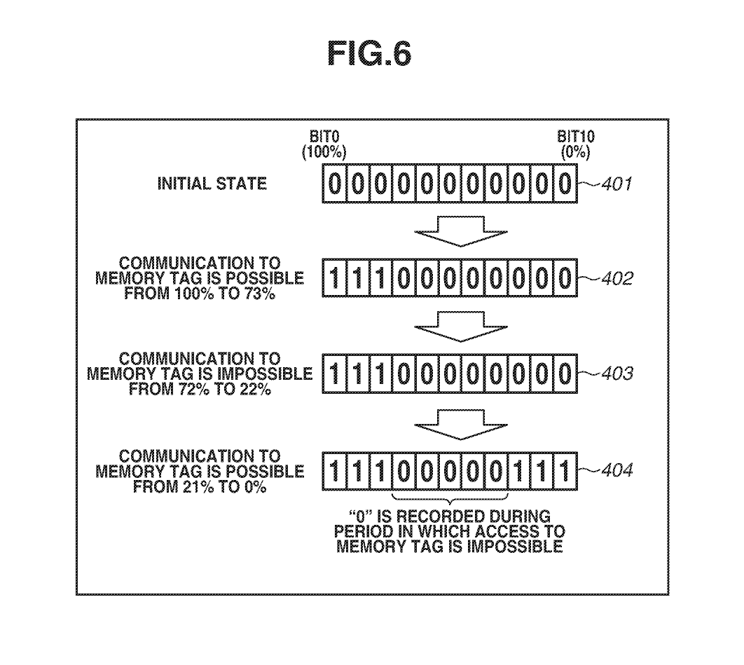

FIG. 6 is a diagram illustrating an example of data recorded on the memory tag 229 as a result of information processing performed according to the flowchart of FIG. 5.

Bits BIT0 to BIT10 represent bits 311 to 321 of the consumption result region 305 of the memory tag 229. In an initial state 401 of the memory tag of the cartridge (new cartridge), “0” is currently recorded in all of the bits BIT0 to BIT10. Following that, for example, when the cartridge is attached and the remaining lifetime thereof is 100% (new cartridge) to 73%, the memory tag in a case where normal access to the memory tag is possible enters a state 402. In this state, bits BIT0 to BIT2 become “1”. Next, for example, when the remaining lifetime of the cartridge is 72% to 22%, the memory tag in a case where the apparatus operates while a communication (access) to the memory tag is impossible due to a cause, such as adhesion of toner, enters a state 403. Since, in a period in which access to the memory tag is impossible, rewriting of bits is not performed, bits BIT3 to BIT7 remain “O”, which is an initial value. Finally, for example, when the remaining lifetime of the cartridge is 21% to 0%, the memory tag, in a case where a communication (access) to the memory tag becomes possible again due to, for example, dirt by toner being removed by, for example, attachment and detachment of the cartridge, enters a state 404. In this state, bits BIT8 to BIT10 become “1”.

It is possible for a user, i.e., service engineer, to determine the state in which access to the memory tag 229 was not possible during a period in which the remaining lifetime was 70% to 30% by removing the memory tag 229 from the cartridge and using a tool for memory tag analysis to read out data stored in the consumption result region.

In the first exemplary embodiment, a region with a size of 16 bits is ensured as the consumption result region 305 of the memory tag 229, in which a communication status (access status) to the memory tag 229 is recorded, and a remaining lifetime is allocated to each bit. However, the method of recording a history of remaining lifetimes is not limited to this, and can be any other method as long as it is able to determine the possibility of a communication (access) to the memory tag at a point of each threshold value, for example, in a case where regions usable to store remaining lifetimes as numerical values or character strings are provided for the respective threshold values.

In the first exemplary embodiment, a communication status (access status) to the memory tag 229 can be found by analyzing the consumption result region of the memory tag 229. However, if it is impossible to perform readout from the memory tag 229 without using a special tool, for example, the need to remove the memory tag from the cartridge arises, so that a troublesome and time-consuming work may be imposed on the service engineer.

Therefore, in a second exemplary embodiment, a configuration in which information indicating a consumption result region can be displayed on the operation and display unit 216 of the device 103 is employed. More specifically, the CPU 201 performs control to display, on, for example, the operation and display unit 216, values such as those indicated in, for example, the state 404 illustrated in FIG. 6 of the consumption result region 305 of the memory tag 229, based on, for example, a predetermined operation performed via the operation and display unit 216. This processing is an example of processing for displaying, on a display unit, values for the respective storage regions of a non-volatile memory corresponding to the remaining lifetime.

In the second exemplary embodiment, a communication status (access status) to the memory tag 229 can be easily confirmed by performing a menu operation on a display device of the device 103.

In the second exemplary embodiment, a communication status (access status) to the memory tag 229 is displayed on a display device of the device 103 so that easy confirmation can be attained. In a third exemplary embodiment, in addition to the control described in the first and second exemplary embodiments, an apparatus/device that enables consumable part result information to be confirmed via an external apparatus is described.

The CPU 201 can be configured to transmit, based on a request from an information processing apparatus such as the PC 102 connected via a USB or a network, values such as those in the state 404 illustrated in FIG. 6 of the consumption result region 305 of the memory tag 229 to the information processing apparatus such as the PC 102 requesting the values. In this case, information in which identification information about the device (for example, a serial number of the device assigned at the time of manufacture) and information about the cartridge (for example, information in the regions 301 to 305 illustrated in FIG. 3) that are associated with each other can be transmitted to an external apparatus.

This processing is an example of processing for transmitting, to an external apparatus, values for the respective storage regions of a non-volatile memory corresponding to the remaining lifetime. While the third exemplary embodiment describes, as an example, a case in which information is transmitted to a PC connected via a USB or a network, the third exemplary embodiment is not limited to this. For example, a configuration in which a consumption result region of the memory tag 229 is read out and information obtained by such readout is transmitted to, for example, a server of a vendor connected via a network can be employed. This enables the service engineer to confirm a communication status (access status) to the memory tag 229 without needing to travel to the location of the image forming apparatus.

One or more functions of the above-described exemplary embodiments can be implemented by processing for supplying a program to a system or apparatus via a network or a storage medium and causing one or more processors included in a computer of the system or apparatus to read out and execute the program. The one or more functions can also be implemented by a circuit which implements one or more functions (for example, an application specific integrated circuit (ASIC)).

While exemplary embodiments have been described above in detail as examples, the present disclosure is not limited to such specific exemplary embodiments.

According to the above-described exemplary embodiments, information indicating that there was a period in which access to a consumable part was impossible can be made available.

### OTHER EMBODIMENTS

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-199703, filed Oct. 13, 2017, which is hereby incorporated by reference herein in its entirety.

What is claimed is:

1. An image forming apparatus comprising:
an acquisition unit configured to acquire a remaining lifetime of a consumable part; and
a control unit configured to record, in a case where access to a memory of the consumable part is possible, a set value in a storage region of the memory corresponding to the remaining lifetime.

2. The image forming apparatus according to claim 1, further comprising a determination unit configured to determine whether access to the memory is possible,
wherein the control unit records the set value if it is determined that access to the memory is possible.

3. The image forming apparatus according to claim 1, wherein in a case where access to the memory of the consumable part is possible, the control unit records a set value in a storage region of the memory corresponding to a remaining lifetime range to which the remaining lifetime belongs from among a plurality of remaining lifetime ranges.

4. The image forming apparatus according to claim 1, further comprising an output unit configured to output a value for every storage region of the memory corresponding to the remaining lifetime.

5. The image forming apparatus according to claim 4, wherein the output unit displays, on a display unit, a value for every storage region of the memory corresponding to the remaining lifetime.

6. The image forming apparatus according to claim 4, wherein the output unit transmits a value for every storage region of the non-volatile memory corresponding to the remaining lifetime.

7. The image forming apparatus according to claim 1, wherein the consumable part is a cartridge in which a recording material used for image formation is contained.

8. The image forming apparatus according to claim 1, wherein the image forming apparatus is a three-dimensional (3D) printer.

9. An information processing method that an image forming apparatus performs, the information processing method comprising:
acquiring a remaining lifetime of a consumable part; and
recording, in a case where access to a memory of the consumable part is possible, a set value in a storage region of the memory corresponding to the remaining lifetime.

10. The information processing method according to claim 9, further comprising determining whether access to the memory is possible, wherein a set value is recorded if it is determined that access to the memory is possible.

11. The information processing method according to claim 9, further comprising, in a case where access to the memory of the consumable part is possible, recording a set value in a storage region of the memory corresponding to a remaining lifetime range to which the remaining lifetime belongs from among a plurality of remaining lifetime ranges.

12. The information processing method according to claim 9, further comprising outputting a value for every storage region of the memory corresponding to the remaining lifetime.

13. The information processing method according to claim 12, further comprising displaying, on a display unit, a value for every storage region of the memory corresponding to the remaining lifetime.

14. The information processing method according to claim 12, further comprising transmitting a value for every storage region of the memory corresponding to the remaining lifetime.

15. A non-transitory computer-readable storage medium storing computer-executable instructions that, when executed by a computer, cause the computer to perform an information processing method that an image forming apparatus performs, the information processing method comprising:
acquiring a remaining lifetime of a consumable part; and
recording, in a case where access to a memory of the consumable part is possible, a set value in a storage region of the memory corresponding to the remaining lifetime.
